(19) United States
(12) Patent Application Publication
(10) Pub. No.: US 2012/0308283 A1
(43) Pub. Date: Dec. 6, 2012

(54) IMAGE FORMING APPARATUS

(75) Inventors: Yohei ITO, Toyokawa-shi (JP); Yoshiki NAKANE, Toyokawa-shi (JP); Kuniaki KASHIWAKURA, Toyohashi-shi (JP); Hokuto HATANO, Hachioji-shi (JP)

(73) Assignee: Konica Minolta Business Technologies, Inc., Tokyo (JP)

(21) Appl. No.: 13/486,944

(22) Filed: Jun. 1, 2012

(30) Foreign Application Priority Data
Jun. 2, 2011 (JP) 2011-124523

(51) Int. Cl. G03G 21/00

(52) U.S. Cl. 399/346

(57) ABSTRACT

An image forming apparatus having: an image carrier that moves in a direction while holding a toner image on its surface; a cleaner that is located downstream from a transfer point where a toner image is transferred from the image carrier, with respect to the moving direction of the image carrier, to remove residual toner and other residues from the surface of the image carrier; a lubricant supply device for supplying a lubricant to the surface of the image carrier; and a flattener for spreading out the lubricant supplied from the lubricant supply device over the surface of the image carrier by pressing its edge portion against the surface of the image carrier; wherein the flattener has an impact resilience within a range of 48% to 68% under temperature of 25° C., and the edge portion of the flattener is arranged counter the moving direction of the image carrier.

This application is based on Japanese Patent Application No. 2011-124523 filed on Jun. 2, 2012, the content of which is incorporated herein by reference.

### BACKGROUND OF THE INVENTION

1. Field of the Invention

The present invention relates to an image forming apparatus, and more particularly to an image forming apparatus such as an electrophotographic copying machine or printer.

In an electrophotographic image forming apparatus, generally, after transfer of a toner image from an image carrier that moves while holding a toner image thereon (specifically, a photosensitive drum on which a toner image is formed or an intermediate transfer belt that receives the toner image transferred from the photosensitive drum), residual toner and other residues are removed from the image carrier by a cleaner, for example, a blade pressed against the surface of the image carrier. Repetitions of such a cleaning operation causes abrasion of the cleaner, thereby resulting in degradation of the cleaning performance, and abrasion of the surface of the image carrier, thereby resulting in a short life of the image carrier.

In order to avoid this trouble, conventionally, a lubricant is supplied from a lubricant supply device onto the surface of the image carrier after transfer of a toner image from the image carrier to a recording medium. The lubricant weakens the friction between the surface of the image carrier and the cleaner, and also makes it easier for a toner image on the image carrier to separate therefrom, which results in good transfer of the toner image onto a recording medium.

Japanese Patent Laid-Open Publication No. 2006-251751 teaches that a cleaner, a brush roll for feeding a lubricant and a flattener that are arranged in this order in the rotating direction of the image carrier are pressed against the surface of the image carrier in sequence such that after removal of residual toner and other residues from the surface of the image carrier, lubricant particles are fed to the surface of the image carrier by the brush roll and are pushed by the flattener onto the surface of the image carrier to be spread out as a coating. As the brush roll for feeding the lubricant particles, generally, a straight-bristle brush is used. The straight-bristle brush, like a toothbrush, has tips of bristles on the brush surface, and therefore, the straight-bristle brush has the following cutback.

The lubricant is solid and soft, and the lubricant is scraped away through its use. At the early stage, the lubricant is scraped uniformly. However, as a concavity is being formed on the surface of the lubricant, most of the bristles of the brush come into the concavity, while the bristles hardly come into contact with the convexity, and thus, the concave portion of the solid lubricant is concentrically scraped. Thus, as the lubricant is consumed further, the concavity becomes large, and finally, it becomes impossible to scrape the lubricant. Consequently, it becomes impossible to supply the lubricant to the image carrier.

### SUMMARY OF THE INVENTION

An image forming apparatus according to an aspect of the present invention comprises: an image carrier that moves in a direction while holding a toner image on its surface; a cleaner that is located downstream from a transfer point where a toner image is transferred from the image carrier, with respect to the moving direction of the image carrier, to remove residual toner and other residues from the surface of the image carrier; a lubricant supply device for supplying a lubricant to the surface of the image carrier; and a flattener for spreading out the lubricant supplied from the lubricant supply device over the surface of the image carrier by pressing its edge portion against the surface of the image carrier; wherein the flattener has an impact resilience within a range of 48% to 68% under temperature of 25° C., and the edge portion of the flattener is arranged counter the moving direction of the image carrier.

### BRIEF DESCRIPTION OF THE DRAWINGS

This and other features of the present invention will be apparent from the following description with reference to the accompanying drawings, in which:

FIG. 1 is a schematic view showing the structure of an essential part of an image forming apparatus;

FIG. 2 is a sectional view showing an action of a flattener for spreading lubricant particles; and

FIGS. 3a and 3b are plan views showing an action of a flattener for spreading lubricant particles.

### DETAILED DESCRIPTION OF THE PREFERRED EMBODIMENTS

An image forming apparatus according to an embodiment of the present invention will be hereinafter described with reference to the drawings.

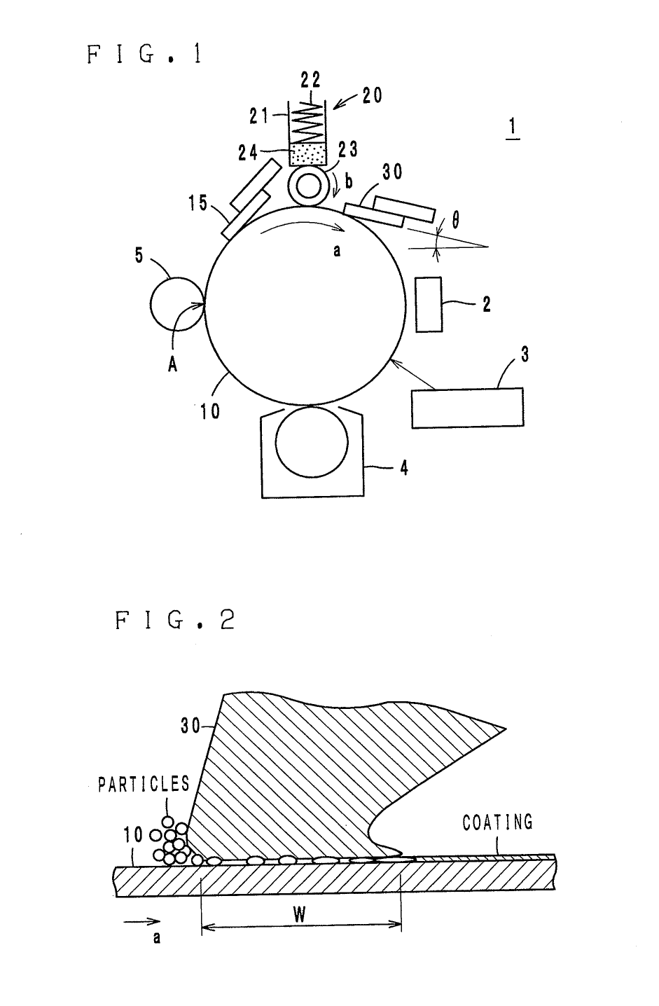

An image forming apparatus 1 according to an embodiment of the present invention is, as shown by FIG. 1, to form a toner image on a photosensitive drum 10 by a conventional electrophotographic process. Around the photosensitive drum 10, a charger 2, an exposure unit 3, a developing device 4 and a transfer device 5 are arranged in this order in the rotating direction of the photosensitive drum 10 (shown by arrow a). At a downstream position, in the photosensitive drum rotating direction, from a transfer point A where the toner image is transferred to a recording medium such as paper, a cleaning blade 15 for removing residual toner and other residues from the surface of the photosensitive drum 10 is provided such that the edge of the cleaning blade 15 is pressed against the photosensitive drum 10 at a specified pressure counter to the rotation of the photosensitive drum 10. The cleaning blade 15 is a sheet of polyurethane rubber.

At a downstream position, in the photosensitive drum rotating direction, from the cleaning blade 15, a lubricant supply device 20 is provided, and at a more downstream position, a flattener 30 is provided. The lubricant supply device 20 comprises a lubricant tank 21, a spring 22 and a feeder 23. The spring 22 presses a lubricant (solid lubricant) 24 stored in the lubricant tank 21, and the feeder 23 scrapes the lower surface of the lubricant 24. The feeder 23 is driven to rotate in a direction shown by arrow b, and with this rotation, the feeder 23 feeds particles of the lubricant 24 to the surface of the photosensitive drum 10. The lubricant particles fed to the surface of the photosensitive drum 10 are crashed and spread over the photosensitive drum 10 as a lubricant coating by the flattener 30.

The feeder 23 is a roller having a circular cross-section. The feeder 23 is driven to rotate counter the rotating direction (shown by arrow a) of the photosensitive drum 10 at a linear velocity lower than that of the photosensitive drum 10, and in this embodiment, specifically, at a linear velocity that is 0.4 times that of the photosensitive drum 10. In the experiments which will be described later, as the feeder 23, straight-bristle brushes having fibers planted one by one thereon and a looped-bristle brushes having looped bunches of fibers planted thereon were used.

The straight-bristle brushes that were used for the experiments were made of conductive polyester and had brushing resistance values within a range of 10⁹Ω to 10¹⁰Ω. The fibers were 4T (decitex) in gauge, and the density of the fibers was 70 KF/inch². Each of the brushes had an iron shaft that was 6 mm in diameter. Each of the brushes was 12 mm in diameter, and the fibers were woven into a base cloth with a thickness of about 0.5 mm. Therefore, the lengths of the fibers were about 2.5 mm.

The looped-bristle brushes that were used for the experiments were made of conductive polyester and had brushing resistance values within a range of 10⁹Ω to 10¹⁰Ω. The fibers were 4T (decitex) in gauge, and the fibers were planted at a density of 120 KF/inch². Each of the brushes had an iron shaft that was 6 mm in diameter. Each of the brushes was 12 mm in diameter, and the fibers were woven into a base cloth with a thickness of about 0.5 mm. Therefore, the lengths of the fibers were about 2.5 mm.

The solid lubricant 24 is formed of metal soap powder by melting/shaping, and in this embodiment, zinc stearate is used. The solid lubricant 24 pressed by the spring 22 is scraped and fed to the surface of the photosensitive drum 10 with the rotation of the feeder 23. The lubricant particles fed to the surface of the photosensitive drum 10 are crashed and spread over the photosensitive drum 10 as a lubricant coating by the flattener 30.

The flattener 30 is a sheet of polyurethane rubber, and the edge thereof, which has a corner of 90 degrees, is in contact with the surface of the photosensitive drum 10. The edge is pressed counter the rotating direction (shown by arrow a) of the photosensitive drum 10. The lubricant coating, which is a coating of zinc stearate, is readily releasable, that is, has a high water contact angle and has a low coefficient of friction. Accordingly, toner is readily transferred from the coating, and the coating is readily cleanable. Also, the lubricant coating slows down the wearing of the photosensitive drum 10 and prolongs the life of the photosensitive drum 10.

The flattener 30 flattens the lubricant particles into a coating as shown by FIG. 2. Zinc stearate is sufficiently spreadable, and as soon as it has been fed to the surface of the photosensitive drum 10, it is partly formed into a coating by the brushing action of the feeder 23. The remaining part mostly held in particle state reaches the flattener 30. The width of the contact portion (nip width W) where the edge of the flattener 30 is in contact with the photosensitive drum 10 depends on the hardness of the flattener 30. Polyurethane rubber, which is the material of the flattener 30, is a viscoelastic material, and the hardness thereof in static condition is different from the hardness thereof in moving condition keeping in contact with the photosensitive drum 10 (dynamic elasticity). When stress fluctuation occurs on the polyurethane runner flattener 30 due to the contact with the photosensitive drum 10, the dynamic elasticity of the contact portion (the portion where vibration is transmitted) becomes larger than the Young's modulus. The ratio of the dynamic elasticity to the Young's modulus significantly depends on the impact resilience, and the smaller the impact resilience, the larger the ratio of the dynamic elasticity to the Young's modulus, that is, the harder. When comparing materials with the same Young's modulus, the larger the impact resilience, the less likely that the contact portion in contact/moving condition becomes harder, and accordingly, the larger the nip width W between the flattener 30 and the photosensitive drum 10.

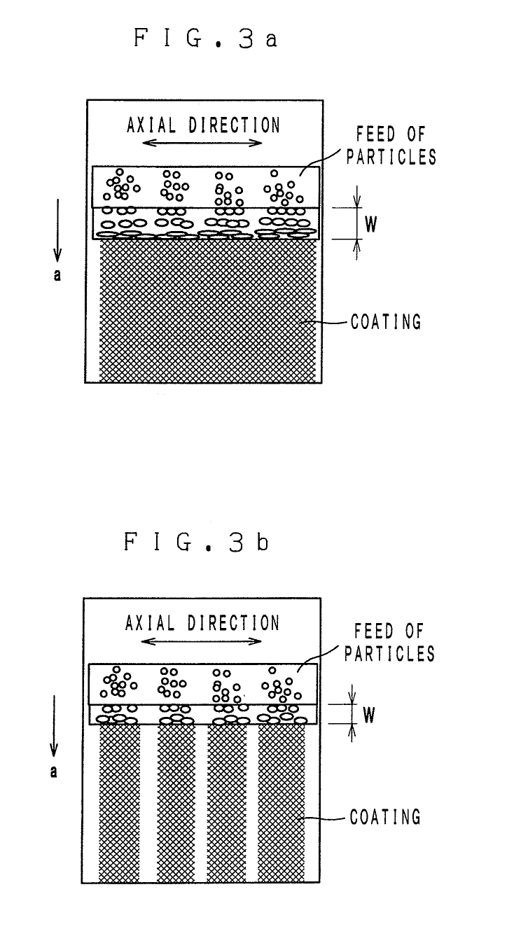

FIG. 3a schematically shows processes from a feed of lubricant particles to formation of a lubricant coating when the impact resilience of the flattener 30 is adequate. FIG. 3b schematically shows processes from a feed of lubricant particles to formation of a lubricant coating when the impact resilience of the flattener 30 is relatively small. The feed of lubricant particles to the surface of the photosensitive drum 10 by the feeder 23 is inevitably accompanied by lubricant feeding unevenness in the axial direction. Then, when the flattener 30 with small impact resilience is used, the nip width W is small, and the time for which the lubricant particles are spread out by the nip portion is short. In this case, consequently, the lubricant spreading performance is low, and it is difficult to flatten the lubricant particles that were fed unevenly by the feeder 23.

On the other hand, when the flattener 30 has relatively large impact resilience, the nip width W is large, and the time for which the lubricant particles are spread out by the nip portion is long. In this case, consequently, the lubricant spreading performance is high, and the lubricant particles that were fed unevenly by the feeder 23 can be flattened. However, if the impact resilience of the flattener 30 is too large, there is a tendency that the cleaning performance of the cleaning blade 15 degrades as the image forming apparatus is being used for a long term. Therefore, it is preferred that the impact resilience of the flattener 30 is within a range of 48% to 68%. It shall be noted that the values of the impact resilience are ones measured in conformity with the impact resilience test defined by JISK6301.

Table 1 below shows evaluation results of images that were formed by examples 1 to 16 according to the present invention and by comparative examples 1 to 8. The flatteners 30 that were used in the examples 1 to 16 according to the present invention were made of materials with relatively large impact resilience, and the flatteners 30 that were used in the comparative examples 1 to 8 were made of materials with relatively small impact resilience.

The experiments were conducted by using apparatuses of the structure as shown by FIG. 1 and solid lubricants as described above. In each of the apparatuses, the diameter of the photosensitive drum was 60 mm, and the process speed (corresponding to the circumferential speed) of the photosensitive drum was 300 mm/s. The pressure applied from the spring to the solid lubricant was 4N/m. The cleaning blade had JIS-A hardness of 72° and had impact resilience of 25%. The cleaning blade was disposed such that the cleaning blade was in contact with the photosensitive drum at an angle of 15° at a pressure of 25N/m. In regard to the flatteners used for the experiment, as shown in Table 1, the JIS-A hardness varied from 52° to 78°, and the impact resilience at temperature of 25° C. varied from 48% to 75%. These flatteners were disposed such that each was in contact with the photosensitive drum at an angle of 10° at a pressure of 20N/m.

It is preferred that the flattener is in contact with the photosensitive drum at an angle θ (see FIG. 1) of 5° to 15° so as to ensure the contact of the edge portion of the flattener with the photosensitive drum and to prevent the edge portion of the flattener from riding up. Also, it is preferred that the flattener is in contact with the photosensitive drum at a pressure of 10N/m to 30N/m so as to allow the fed lubricant to pass through the contact portion between the flattener and the photosensitive drum adequately and to spread the lubricant thoroughly. Here, the pressure is expressed by a linear pressure, that is, a quotient of a division of the force for pressing the flattener against the photosensitive drum by the length (the dimension along the edge portion) of the flattener.

As an experiment, a chart having a portion with image coverage of 0% and a portion with image coverage of 100% was printed out on 500 sheets continuously in a monochromatic mode under temperature of 30° C. and humidity of 85% RH. Thereafter, a halftone image was formed, and the printed halftone image was evaluated whether it had stripe noise. Specifically, the evaluation was conducted by dividing the printed halftone image into a portion corresponding to the portion with image coverage of 0% of the previously printed chart and a portion corresponding to the portion with image coverage of 100% of the previously printed chart. Next, as another experiment, density unevenness of halftone images due to insufficient cleaning of the photosensitive drum was examined. Specifically, a chart with image coverage of 5% was printed out on 100000 sheets by repeating a 4-sheet monochromatic print job, and the 10000th printed image, the 30000th printed image and 100000th printed image were evaluated whether they had density unevenness.

TABLE 1

| | Properties of Flattener | | | | | | | |
|---|---|---|---|---|---|---|---|---|
| | | Impact | Type of | Stripe Noise | | Density Unevenness due to Cleaning Failure | | |
| | | Resilience | Lubricant | Coverage: | Coverage: | Endurance: | Endurance: | Endurance: |
| | Hardness | at 25° C. | Feeder | 0% | 100% | 10000 sheets | 30000 sheets | 100000 sheets |
| Example 1 | 71° | 62% | Looped- | A | A | A | B | B |
| Example 2 | 70° | 50% | Bristle | A | A | A | A | B |
| Example 3 | 70° | 68% | Brush | A | A | A | B | B |
| Example 4 | 77° | 58% | | B | A | A | A | B |
| Example 5 | 79° | 48% | | B | A | A | A | B |
| Example 6 | 77° | 65% | | B | A | A | B | B |
| Example 7 | 61° | 60% | | A | A | A | B | B |
| Example 8 | 61° | 50% | | A | A | A | B | B |
| Example 9 | 62° | 66% | | A | A | B | B | C |
| Example 10 | 87° | 49% | | C | B | A | A | A |
| Example 11 | 52° | 51% | | A | A | B | B | C |
| Example 12 | 71° | 62% | Straight- | A | A | B | B | C |
| Example 13 | 70° | 50% | Bristle | A | A | A | B | B |
| Example 14 | 70° | 68% | Brush | A | A | B | B | C |
| Example 15 | 61° | 60% | | A | A | B | B | C |
| Example 16 | 77° | 58% | | A | A | A | B | B |
| Comp. Example 1 | 78° | 73% | Looped- | B | A | B | C | D |
| Comp. Example 2 | 62° | 75% | Bristle | A | A | C | D | D |
| Comp. Example 3 | 78° | 45% | Brush | D | D | A | A | A |
| Comp. Example 4 | 62° | 43% | | D | C | A | B | B |
| Comp. Example 5 | 78° | 73% | Straight- | A | A | B | D | D |
| Comp. Example 6 | 62° | 75% | Bristle | A | A | D | D | D |
| Comp. Example 7 | 78° | 45% | Brush | D | C | A | B | B |
| Comp. Example 8 | 62° | 43% | | C | C | B | C | D |

Stripe noise results from feeding unevenness of lubricant particles to the photosensitive drum by the lubricant feeder, which appears as unevenness in the coefficient of friction of the surface of the photosensitive drum. The lubricant layer in the part of the photosensitive drum where a portion with image coverage of 0% was formed is not scraped off together with toner during a cleaning action of the cleaning blade 15, and in this part, unevenness in the coefficient of friction due to feeding unevenness of lubricant particles appears remarkably. Thus, stripe noise is apt to occur in the part corresponding to the portion with image coverage of 0% of the previously printed chart.

Density unevenness results from the fact that the lubricant coating in the part of the photosensitive drum where a portion with image coverage of 0% was formed tends not to be scraped off as mentioned, while the lubricant coating in the part of the photosensitive drum where a portion with image coverage of 100% was formed tends to be scraped off. Accordingly, the coefficient of friction of the photosensitive drum in the part where a portion with image coverage of 0% was formed lowers more largely than that in the part where a portion with image coverage of 100% was formed. This causes a difference in the transfer efficiency between the part where a portion with image coverage of 0% was formed and the part where a portion with image coverage of 100% was formed, which results in density unevenness.

In Table 1, the level of images with completely no problems is evaluated as A. The level of images with visible blemishes not causing problems is evaluated as B. The level of images with visible blemishes not causing practical problems is evaluated as C. The level of images with visible blemishes causing practical problems is evaluated as D.

As shown by Table 1, when the impact resilience at temperature of 25° of the flattener was within a range of 48% to 68%, the evaluations of the images in regard to both stripe noise and density unevenness were good. Although not shown in Table 1, good results can be obtained at least when the flattener is in contact with the photosensitive drum at an angle of 5° to 15° at a pressure of 10N/m to 30N/m.

The material of the lubricant feeder may be not only polyester but also rayon, acryl, polyamide or metal fiber. Also, the lubricant feeder may be made of insulating fiber. The lubricant feeder may be an electrostatic flocking brush. Further, the lubricant feeder does not necessarily need to be a brush but may be a solid body or a foam roller of urethane or silicon.

In the embodiment above, the lubricant is a solid lubricant made of zinc stearate. However, metal salt of fatty acid such as magnesium stearate, lithium stearate or the like may be used.

The structure of the electrophotographic image forming section and the configuration of the control unit can be arbitrarily designed. It should be noted that the present invention is applicable not only to a monochromatic image forming apparatus but also to a color image forming apparatus. In the latter case, the above-described approach shall be applied to an intermediate transfer belt.

Although the present invention has been described in connection with the preferred embodiment above, it is to be noted that various changes and modifications are possible to those who are skilled in the art. Such changes and modifications are to be understood as being within the scope of the present invention.

What is claimed is:

1. An image forming apparatus comprising:
an image carrier that moves in a direction while holding a toner image on its surface;
a cleaner that is located downstream from a transfer point where a toner image is transferred from the image carrier, with respect to the moving direction of the image carrier, to remove residual toner and other residues from the surface of the image carrier;
a lubricant supply device for supplying a lubricant to the surface of the image carrier; and
a flattener for spreading out the lubricant supplied from the lubricant supply device over the surface of the image carrier by pressing its edge portion against the surface of the image carrier;
wherein the flattener has an impact resilience within a range of 48% to 68% under temperature of 25° C., and the edge portion of the flattener is arranged counter the moving direction of the image carrier.

2. An image forming apparatus according to claim 1, wherein the flattener has a hardness (JIS-A) within a range of 52° to 87° under temperature of 25° C.

3. An image forming apparatus according to claim 1, wherein the edge portion of the flattener has a corner of 90 degrees.

4. An image forming apparatus according to claim 1, wherein the flattener is pressed against the image carrier at an angle within a range of 5 degrees to 15 degrees at a pressure within a range of 10N/m to 30N/m.

5. An image forming apparatus according to claim 1, wherein the lubricant supply device comprises a brush having looped bristles.
